(19) United States
(12) Patent Application Publication
(10) Pub. No.: US 2006/0225924 A1
(43) Pub. Date: Oct. 12, 2006

(54) Apparatus and method for recovering oil-based drilling mud

(76) Inventors: Catalin Ivan, Sugar Land, TX (US); Neale Browne, Houston, TX (US)

Correspondence Address: CARTER J. WHITE LEGAL DEPARTMENT;M-I L.L.C., 5950 NORTH COURSE DRIVE, HOUSTON, TX, 77072, US

(21) Appl. No.: 11/102,952

(22) Filed: Apr. 11, 2005

(51) Int. Cl. E21B 21/06; B01F 13/00

(52) U.S. Cl. 175/66; 366/342

(57) ABSTRACT

Oil-based drilling fluid is prepared for further processing to recover the drilling fluid by pumping the drilling fluid through a flow meter. Surfactant may be added to the drilling fluid by using a dose pump and a flow meter. The drilling fluid and surfactant are then blended by passing them through a static mixer. A flocculating polymer is transferred via dose-pumps to another static mixer where it is blended with the surfactant and drilling fluid mixture. To ensure adequate mixing and reaction, additional mixers are included through which the mixture passes. A centrifuge is used to separate solid particles from the fluid.

### BACKGROUND OF INVENTION

In the process of rotary drilling a well, drilling fluid, or mud, is circulated down the rotating drill pipe, through the bit, and up the annular space between the pipe and the formation or steel casing, to the surface. The drilling fluid performs different functions such as removal of cuttings from the bottom of the hole to the surface, to suspend cuttings and weighting material when the circulation is interrupted, control subsurface pressure, isolate the fluids from the formation by providing sufficient hydrostatic pressure to prevent the ingress of formation fluids into the wellbore, cool and lubricate the drill string and bit, maximize penetration rate, etc.

The required functions can be achieved by a wide range of fluids composed of various combinations of solids, liquids and gases and classified according to the constitution of the continuous phase mainly in two groupings: aqueous drilling fluids, and oil-based drilling fluids. In drilling water-sensitive zones such as reactive shales, production formations, or where bottom hole temperature conditions are severe or where corrosion is a major problem, oil-based drilling fluids are preferred.

Oil-based drilling fluids typically contain oil-soluble surfactants that facilitate the incorporation of water-wet clay or non-clay formation minerals, and hence enable such minerals to be transported to surface equipment for removal from circulation before the fluid returns to the drill pipe and the drill bit. The largest formation particles are rock cuttings, the size typically larger than 0.1 to 0.2 mm, removed by shale-shaker screens at the surface. Smaller particles, typically larger than about 5 μm, will pass through the screens, and must be removed by centrifuge or other means.

Oil-based drilling fluids have been used for many years, and their application is expected to increase, partly owing to their several advantages over water based drilling fluids, but also owing to their ability to be re-used and recycled, so minimizing their loss and their environmental impact.

As mentioned above, during drilling, formation particles become incorporated into the drilling fluid. Unless these are removed, they eventually alter the fluid's properties, particularly the Theological parameters, out of the acceptable range. However, formation particles that are less than about 5 to 7 μm in size are more difficult to remove than larger particles. These low gravity solids can build up in a mud system, causing inefficient drilling problems such as drill pipe sticking, increased pipe torque, and other high viscosity issues.

While low gravity solids may be removed from drilling fluids using mechanical means such as a centrifuge, it has been found that longer run-times are required to remove the colloidal particles, if the low gravity solids can be removed at all. Thus, there is a need for an apparatus that can be used with traditional solids separation equipment to reduce the run-time required to remove low gravity solids. Further, it would be an improvement in the art to have an apparatus that can be utilized both on active drilling projects to facilitate solids control equipment efficiency as well as by mud plants in reclaiming and/or reconditioning mud returned from field operations.

### SUMMARY

In one aspect, the claimed subject matter is generally directed to an apparatus for preparing an oil-based drilling fluid for recovery. The apparatus includes a first static mixer in which the oil-based drilling fluid and a surfactant are mixed. In a second static mixer a flocculant and a base fluid may be mixed. The flocculant mixture is added to the drilling fluid mixture and further mixing occurs through a series of additional mixers. Upon exiting the final mixer, the drilling fluid mixture is prepared to have solids separated therefrom so that the oil-based drilling fluid may be further processed for recovery. A centrifuge may be used to separate solids from the remaining effluent.

In another illustrated aspect, the claimed subject matter is directed to an apparatus for reclaiming oil-based drilling fluid and recovering valuable weighting agent. The apparatus includes an additional centrifuge to remove the weighting agent prior to the injection of polymer to the oil-based drilling fluid.

In another illustrated aspect, a method for preparing an oil-based drilling fluid for recovery is claimed. The method includes demulsifying the drilling fluid with a surfactant and preparing a flocculant mixture. The flocculant mixture is then mixed with the drilling fluid mixture. The next step includes separating solids from the drilling fluid mixture and collecting them. Effluent from the separating solids step may be collected for further processing.

Other aspects and advantages of the claimed subject matter will be apparent from the following description and the appended claims.

### BRIEF DESCRIPTION OF THE DRAWINGS

FIG. 1 is a schematic of an apparatus for preparing an oil-based drilling fluid for recovery.

FIG. 2 is a schematic of an alternative embodiment of an apparatus for preparing an oil-based drilling fluid for recovery.

FIG. 3 is a layout of the apparatus mounted on a skid.

### DETAILED DESCRIPTION

The claimed subject matter relates to an apparatus and method for preparing an oil-based drilling fluid for recovery. The oil-based drilling fluid includes oil, water, and solids in relative proportions consistent with used drilling fluid that has been subjected to preliminary processes to remove large solids from the fluid. The solids remaining in the drilling fluid typically include a percentage of high gravity solids and a percentage of low gravity solids. High gravity solids are those solids that are dense, as in barite or hematite, while low gravity solids are those solids that have a lower density than barite. The oil and water in the used drilling fluid are present in proportionate amounts, the relationship between them often being expressed as an oil-to-water ratio.

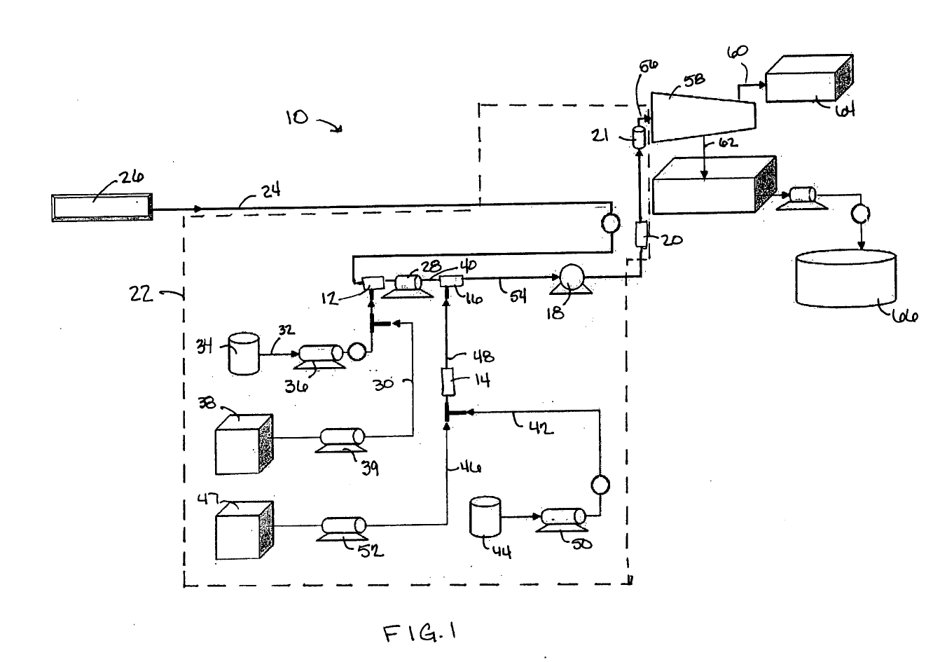

In a first embodiment, shown in FIG. 1, the apparatus 10 includes a plurality of mixers 12-20 that may be mounted to a common skid 22. Oil-based drilling fluid 24 is pumped from a mud plant 26 to the first mixer 12. A pump 28 may be used to introduce the drilling fluid 24 to the first mixer 12 with a predetermined pressure and flow rate. A surfactant 32 is pumped into the first mixer 12 from a surfactant tank 34. The surfactant 32 may be diluted with water 30 from water tank 38 prior to its introduction to the first mixer 12. A dose pump 36 may be used to introduce the surfactant 32 to the mixer with a predetermined pressure and flow rate. The surfactant 32 acts on the mud solids, improving their hydrophilicity so that the polymer, which is very hydrophilic and added downstream, can flocculate the solids.

The first mixer 12 preferably is a static shear mixer including an insert (not shown) that provides shear to the fluid passing through the first mixer 12 sufficient to mix the surfactant 32 and the drilling fluid 24. The surfactant 32 and the drilling fluid 24 are introduced to the first mixer 12 upstream from the insert and exit the mixer 12 as a surfactant treated mud 40.

A flocculant polymer 42 is stored in a flocculant storage tank 44 and ma) be mixed with a base fluid 46, when necessary, to form a flocculant mixture 48. The dilution of the flocculant polymer 42 with the base fluid 46 can improve the dispersal of the polymeric droplets into the mud. The decision to do this or not is based on the type of dosing equipment, the viscosities of the mud 24 and the flocculant polymer 42, and the strength to the mixing employed.

Dosing pumps 50, 52 may be used to introduce the flocculant 42 and the base fluid 46, respectively, to the second mixer 14 in predetermined relative quantities. The second mixer 14 preferably is a static shear mixer including an elongated insert to enhance the dispersion of flocculant 42 within the base fluid 46 and to provide turbulence to the flow. The turbulence created by the insert causes the flocculant 42 and the base fluid 48 to form the flocculant mixture 48.

The flocculant mixture 48 is mixed with the surfactant treated mud 40 in a third mixer 16. Like the first mixer 12, the third mixer 16 preferably is a static mixer including an insert to provide shear to the passing fluids sufficient to mix the fluids together. The addition of flocculant 48 to the surfactant treated mud 40 causes solid material in the surfactant treated mud 40 to coagulate around the flocs. Creating larger solid masses aids in their later removal from the drilling fluid.

The treated mud 54 is mixed further in additional downstream mixers 18, 20. Preferably, a fourth mixer 18 is a dynamic mixer. In the dynamic mixer 18, the treated mud 54 is subjected to agitation providing additional shearing to facilitate the coagulation of solids and floc. Additional mixers 20, 21 may be included. The additional mixers 20, 21 preferably are in-line mixers, providing additional mixing by subjecting the drilling fluid and polymer mixture 54 to shear as in the second mixer 14 discussed earlier. By including a plurality of mixers downstream from the injection of flocculant polymer 48, the exposure of solids to the flocculant is enhanced prior to directing the treated mud 54 to a separation process.

Upon exiting the final mixer 21, the treated mud 54 is a prepared mud mixture 56 ready for further processing to remove the solids from the fluid. The prepared mud mixture 56 may be directed to equipment outside of the skid 22 for additional processing. Such equipment may include a centrifuge 58 to which the prepared mud mixture 56 is directed. The centrifuge 58 includes a bowl that is rotated at a speed sufficient to separate the solids 60 in the prepared mud mixture 56 from the fluid, or effluent 62. As the solids 60 are discharged from the centrifuge 58, they may be collected in a cuttings box 64. Effluent 62 may be released to a fluid storage area 66, or directed to additional equipment (not shown) for further processing.

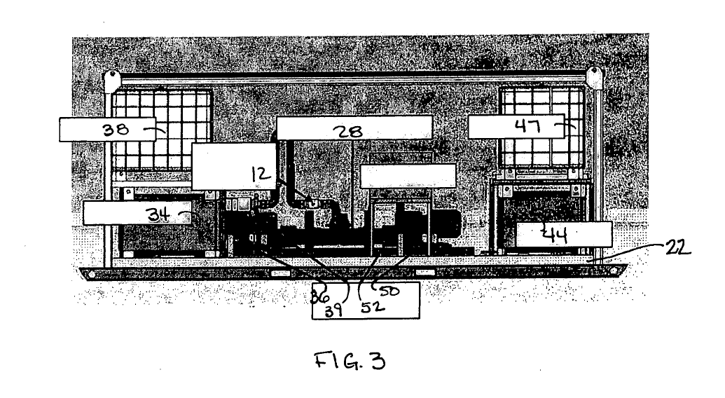

As previously stated, the equipment required to process the drilling fluid 24 prior to its being directed to the centrifuge 58 may be housed on a skid 22. To consolidate the equipment onto a single skid 22, attention must be given to the layout of the equipment. In a preferred embodiment, shown in FIG. 3, water and base oil tanks 38, 47 are positioned directly above the surfactant and polymer tanks 34, 44. The water and base totes 38, 47 may be placed on rails so that they are movable to an outward position, away from the polymer and surfactant tanks 34, 44 for refilling.

Dosing pumps 36, 39, 50, 52 may be positioned on the skid 22 such that the polymer and base oil pumps are directly beside their respective tanks with one pump placed atop another to conserve space. Likewise, the surfactant and water pumps may be stacked to conserve space.

The flocculant polymer 42 or flocculant mixture 48 added to the drilling fluid enhances removal of the solids 60 by the centrifuge 58 by forming larger solid particles. The polymer droplets have to be well dispersed into the mud to be flocculated, without dissolving the polymer. The droplets remain intact and adhere the solids in the mud together, thus greatly improving the solid-liquid separation efficiency upon centrifugation. In order to derive the most benefit from the polymeric droplets as a flocculant, it is necessary that they be well mixed into the mud, and at an efficacious dose. The amount of flocculant polymer 48 added to the surfactant treated mud 40 should be that sufficient to leave the polymeric droplets homogeneously dispersed throughout the mud 24 to be flocculated.

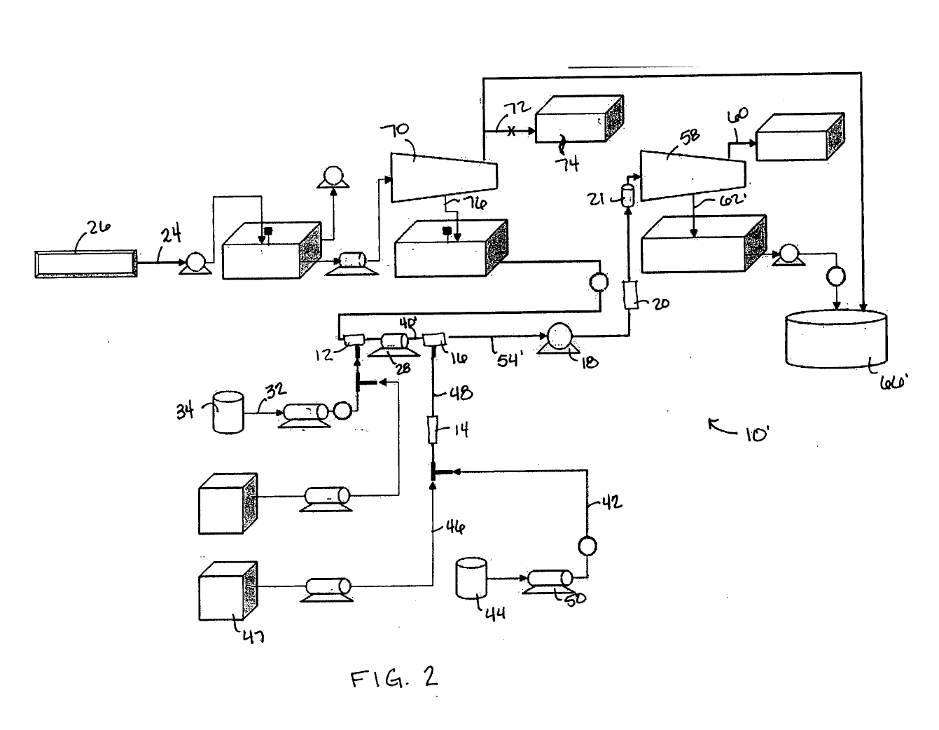

A second embodiment of the apparatus 10′ is shown in FIG. 2. In this embodiment, the drilling fluid 24 is pumped from the mud plant 26 into a first centrifuge 70. The first centrifuge 70 is optimized to recover the weighting agent 72, such as barite, from the drilling fluid 24. The weighting agent 72 is discharged from the first centrifuge 70 to a cuttings box 74 or a storage tank 66′ to be reintroduced to the recovered drilling fluid 62′ discharged from the apparatus 10′. Effluent 76 from the first centrifuge 70 is pumped into the first mixer 12. As previously described, surfactant 32 is injected into the first mixer 12 and the effluent 76 and surfactant 32 are subjected to static shear sufficient to distribute the surfactant through the drilling fluid to form a surfactant treated effluent 40′.

A polymer mixture 48 is made by mixing a flocculant 42 and a base fluid 46 in a mixer 14, if a base fluid is needed. The polymer mixture 48 is directed to mixer 16 where it is mixed with the surfactant treated effluent 40′, as previously described. If a base fluid is not needed, flocculant 42 may be directed to the mixer 16, in which it is mixed directly with the surfactant treated effluent 40′ to form a treated mud 54′.

The treated mud 54′ from the mixer 16 is directed through a series of additional mixers 18, 20, 21 to ensure there is sufficient mixing to prepare the treated mud 54′ for separation and further processing. As previously described, a dynamic mixer 18 and one or more inline mixers 20, 21 are preferred to ensure sufficient mixing of the flocculant 42 within the surfactant treated effluent 40′.

A centrifuge 58 may be used to separate solids 60′ and effluent 62′. The recovered weighting agent 72 from the first centrifuge 70 may be added to the effluent 62′ as needed to reproduce drilling fluid to be used in drilling operations.

While the claimed subject matter has been described with respect to a limited number of embodiments, those skilled in the art, having benefit of this disclosure, will appreciate that other embodiments can be devised which do not depart from the scope of the claimed subject matter as disclosed herein. Accordingly, the scope of the claimed subject matter should be limited only by the attached claims.

What is claimed is:

1. An apparatus for preparing used oil-based drilling fluid for recovery comprising:
a first dosing pump operable to dispense a predetermined amount of surfactant into the oil-based drilling fluid;
a first static mixer through which the oil-based drilling fluid and the surfactant are mixed to form a surfactant treated drilling fluid;
a second dosing pump operable to dispense a predetermined amount of flocculating polymer into the surfactant treated drilling fluid;
a plurality of serially aligned mixers through which the surfactant treated drilling fluid and the flocculating polymer are mixed.

2. The apparatus of claim 1 wherein the plurality of serially aligned mixers includes at least one dynamic mixer.

3. The apparatus of claim 1, wherein the plurality of serially aligned mixers comprises:
a dynamic mixer operable to further mix the surfactant treated drilling fluid and the flocculating polymer;
a plurality of static mixers in fluid communication with the dynamic mixer operable to provide shear to the surfactant treated drilling fluid and the flocculating polymer sufficient to disperse the flocculating polymer throughout the surfactant treated drilling fluid.

4. The apparatus of claim 1, further comprising a flow meter operable to control the flow rate of drilling fluid into the first static mixer.

5. The apparatus of claim 4, further comprising the a flow meter operable to control the flow rate of surfactant into the first static mixer.

6. The apparatus of claim 1, further comprising:
a third dosing pump operable to dispense a predetermined amount of base fluid into the flocculating polymer;
an in-line mixer providing shear force to the base fluid and flocculating polymer sufficient to disperse the flocculating polymer throughout the base fluid;
a surfactant container housing the surfactant;
a flocculating polymer container housing the flocculating polymer;
a base fluid container housing the base fluid;
wherein the surfactant container, the flocculating polymer container, the base fluid container, the first static mixer, the in-line mixer, and the plurality of serially aligned mixers are all affixed to a skid.

7. An apparatus for recovering an oil-based drilling fluid comprising:
a first dosing pump operable to dispense a predetermined amount of surfactant into the oil-based drilling fluid;
a first static mixer through which the oil-based drilling fluid and the surfactant are mixed to form a surfactant treated drilling fluid;
a second dosing pump operable to dispense a predetermined amount of flocculating polymer into the surfactant treated drilling fluid;
a plurality of serially aligned mixers through which the surfactant treated drilling fluid and the flocculating polymer are mixed to form a treated mud;
a centrifuge receiving the treated mud and operable to separate the solids from the recovered drilling fluid.

8. The apparatus of claim 7 wherein the plurality of serially aligned mixers includes at least one dynamic mixer.

9. The apparatus of claim 8 wherein the plurality of serially aligned mixers further includes at least one static mixer.

10. The apparatus of claim 7, further comprising:
a first centrifuge receiving the oil-based drilling fluid and operable to separate the weighting agent from the fluid, wherein the fluid from the first centrifuge is directed to the first static mixer; and
wherein the centrifuge receiving the treated mud is the second centrifuge.

11. The apparatus of claim 10, further comprising:
a storage tank receiving the recovered drilling fluid from the second centrifuge.

12. The apparatus of claim 10 wherein the weighting agent discharged from the centrifuge is directed to the storage tank and added to the recovered drilling fluid.

13. A method for recovering an oil-based drilling fluid comprising:
mixing a predetermined amount of surfactant with an oil-based drilling fluid containing solids to form a surfactant treated drilling fluid;
mixing the surfactant treated drilling fluid with a predetermined amount of flocculating polymer to form a treated mud;
dynamically mixing the treated mud to disperse the flocculating polymer throughout the treated mud;
shearing the treated mud to further disperse the flocculating polymer throughout the treated mud to cause the solids from the oil-based drilling fluid to adhere to the flocculating polymer;
separating the solids adhered to the flocculating polymer from the treated mud;
collecting the separated solids;
collecting the effluent.

14. The method of claim 13, further comprising:
mixing the flocculating polymer with a base fluid before mixing with the surfactant treated drilling fluid.

15. The method of claim 13 wherein the separating step further comprises:
introducing the treated mud to a centrifuge;
rotating the centrifuge to remove solids from the oil-based drilling fluid.

16. The method of claim 13, further comprising:
directing the oil-based drilling fluid containing solids to a first centrifuge;
separating weighting agent from the oil-based drilling fluid before mixing a predetermined amount of surfactant therewith.

17. The method of claim 16, further comprising:
directing the separated weighting agent to the collected effluent from the last separating step.
